(19) United States
(12) Patent Application Publication
(10) Pub. No.: US 2010/0161871 A1
(43) Pub. Date: Jun. 24, 2010

(54) Computer

(76) Inventor: Musa Ibrahim Kakish, Anaheim, CA (US)

Correspondence Address: LAMBERT & ASSOCIATES, P.L.L.C., 92 STATE STREET, BOSTON, MA, 02109-2004, US

(21) Appl. No.: 12/460,336

(22) Filed: Jul. 17, 2009

Related U.S. Application Data
(60) Provisional application No. 61/203,272, filed on Dec. 22, 2008.

(51) Int. Cl. G06F 13/00

(52) U.S. Cl. 710/316

(57) ABSTRACT

An all-in-one computer has a switch button is exposed on the front of the housing for a KVM switch, that is a switch for switching manual input data and VDU data. The KVM switch has a keyboard data input connection, a mouse data input connection, and two VDU data input connections. It has two keyboard and two mouse data output connections and one VDU data output connection. It connects a keyboard and mouse to either of the all-in-one computer and an external, laptop computer and either of their VDU data signals to the all-in-one's VDU.

### CROSS REFERENCE TO RELATED APPLICATION

This application takes priority from and claims the benefit of Provisional Application Ser. No. 61/203,272 filed on Dec. 22, 2008 the contents of which are hereby incorporated by reference.

### BACKGROUND OF THE INVENTION

1. Field of the Invention

The present invention relates to a computer.

2. Description of the Related Art

Personal computers have been known for at least 25 years. They comprise a housing containing the central processor unit and associated devices, a separate visual display unit (VDU), a separate keyboard and a separate mouse. Laptop computers in which all of the separate peripheral devices are combined in one product have been known for at least 15 years. A new configuration is an “all-in-one” computer, in which the central processor unit is incorporated in a housing with the VDU. The keyboard and mouse (or equivalents) may be permanently attached to the housing or they may be separate.

Whilst laptop computers are often used in offices in place of desktop, personal computers, they are essentially mobile devices. Both have their uses and both often run different software and have different data stored on them. In an office, or indeed a home, where a server is provided for central storage and back-up of data, mobile and non-mobile computers can be readily connected to the server for data transfer. Where no server is provided, data can be easily transferred by flash memory devices—so called USB drives.

In a small office or a home, space is at a premium and the facility to operate two computers with two different keyboards can result in awkwardness and inefficient use of space. KVM switches address this in allowing a single VDU, a single keyboard and a single mouse to be used. A KVM switch allows a laptop computer to be controlled by a desktop's keyboard and mouse and its VDU data to be displayed on the desktop's VDU.

This facility is not available the other way around, since a KVM switch is positioned between the computer and its peripheral devices. In a laptop, the “peripheral devices” are integrally, hard-wired.

The same problem arises with an all-in-one computer, at least as regard's its visual display device is concerned, since this is integrally, hard-wired, even if its keyboard and laptop are conventionally connected.

### SUMMARY OF THE INVENTION

The object of the present invention is to provide an improved computer with which KVM switch facility is provided.

Please note that throughout this specification, the term “mouse” is used to mean any cursor pointing device, including a conventional mouse moved across a desk surface, a roller ball, a touch pad or a touch screen. This use is for consistency with the term KVM.

According to the invention there is provided a computer adapted to receive external keyboard, mouse and video data, the computer comprising:
a housing;
a visual display unit (VDU) mounted on the housing;
a central processor unit (CPU) contained in the housing and adapted to accept keyboard and mouse input and to provide video data output;
keyboard and mouse data input means on mounted on the housing;
VDU data input means mounted on the housing;
keyboard and mouse data output means on mounted on the housing;
keyboard, mouse and video (KVM) switch means mounted on or in the housing and connected to:
   the keyboard and mouse data input means to receive external keyboard and mouse data and switch this data to the central processor unit in one state of the switch means or to the keyboard and mouse data output means in another state of the switch means and to
   the CPU and the VDU data input means:
      to receive VDU data from the CPU in one state of the switch means and switch this data to the VDU and
      to receive external VDU data from the VDU data input means in another state of the switch means and switch this data to the VDU and
means for changing the state of the KVM switch means.

Normally the KVM switch means will be an electronic switch device. It may embody switching for all of the keyboard, mouse and video data in a single device, however in one preferred embodiment a first device switches the video data and controls a second device for switching the keyboard and mouse data.

Whilst it can be envisaged that the KVM switch means could have more than two states for switching keyboard and mouse data to a selected one of a plurality of other computers and switching video data from the selected other computer to the VDU of the KVM switch equipped computer; in the preferred embodiment, the switch has two states only for switching between the KVM switch equipped computer and only one other computer.

The KVM switch means may be of the manually operated type. Alternatively, it may be electrically operated by detection of connection to another computer, as by detection of the 5 volts on a USB cable from another computer. Again the KVM switch can be of the type adapted to be operated by detection of a unique key stroke sequence.

Conveniently the keyboard and mouse data output means is a Type B USB socket. Further it is preferably provided with a dedicated input connector for video data from the other computer, the dedicated input connector being discrete from the normal, auxiliary video output connector.

Whilst it is envisaged that the invention could be applied to a laptop computer, to enable its key board and mouse to control another computer, it is primarily intended to enable an all-in-one computer to do this.

In preferred embodiments:
the computer includes:
   a mother board on which the CPU is carried and
   a video bus from the mother board to the VDU and wherein:
the KVM switch means includes a video switch:
   positioned in the video bus between the mother board and the VDU for interconnection of these two or their isolation; and
   connected to the VDU data input means for connection thereof to the VDU when the VDU is not connected to the mother board and vice versa,
the computer includes:
   a USB bus connected to the mother board and wherein:
the keyboard and mouse data input means includes:
   one or more Type A USB socket connected to the USB bus for connection of a keyboard and a mouse and wherein
the KVM switch means includes
   a USB switch is provided between in the USB bus between the mother board and the Type A USB sockets;
wherein the USB switch interconnects portions of the USB bus on either side of it when the video switch interconnects the video bus between the mother board and the VDU,
the keyboard and mouse data output means comprises:
   a Type B USB socket and
the computer includes
   an additional branch of the USB bus connected between the USB switch and the Type B USB socket and
wherein:
   the USB switch is arranged to isolate the additional branch of the USB bus when the said portions of the USB bus are interconnected;
   the USB switch connects the portion of the USB bus connected to the Type A USB sockets to the additional branch of the USB bus and the Type B USB socket, when the said portions are isolated from each other by the USB switch; and
   the additional branch of the USB bus is isolated from USB bus portion connected to the mother board at all times,
the computer includes:
   a USB bus connected to the mother board and wherein:
the keyboard and mouse data input means includes:
   one or more Type A USB socket connected to the USB bus for connection of a keyboard and a mouse and wherein
the keyboard and mouse data output means comprises:
   a Type B USB socket and
   an additional branch of the USB bus connected to the Type B USB socket and
the KVM switch means includes
   a USB hub having two upstream port and one downstream port and means for selectively switching the one or the other of the two upstream ports to the downstream port and wherein
   the downstream port is connected to the or each Type A USB socket for connection of keyboard and mouse data,
   one upstream port is connected to the mother board via the USB bus for connection of the keyboard and mouse data thereto,
   the other upstream port is connected to the Type B USB socket via the additional branch of the USB bus for connection to an external computer for connection of the keyboard and mouse data thereto,
the KVM switch is connected to the Type B USB socket and is adapted to:
   change state and isolate the said portions of the video bus on application of 5 volts from the Type B USB socket to the KVM switch and to
   pass a signal to the USB switch whereby the USB switch disconnects the portions of the USB bus on either side of it when the video switch disconnects the video bus between the mother board and the VDU,
the KVM switch is connected to the Type B USB socket and is adapted to:
   change state and isolate the said portions of the video bus on application of 5 volts from the Type B USB socket to the KVM switch and to
   pass a signal to the USB hub whereby the USB hub disconnects the one upstream port from the downstream port when the video switch disconnects the video bus between the mother board and the VDU.
the computer includes:
   an integral keyboard,
   an integral mouse,
   a USB bus to which the keyboard and mouse are connected, and
   a USB switch is provided between in the USB bus between the mother board and the keyboard and mouse; and
      wherein the USB switch is under the control of the KVM switch and interconnects portions of the USB bus on either side of it when the KVM switch interconnects the said portions of the video bus,
the computer includes:
   a Type B USB socket and
   an additional branch of the USB bus connected between the USB switch and the Type B USB socket and
wherein:
   the USB switch is arranged to isolate the additional branch of the USB bus when the said portions of the USB bus are interconnected;
   the USB switch connects the portion of the USB bus connected to the Type A USB sockets to the additional branch of the USB bus and the Type B USB socket, to when the said portions are isolated from each other by the USB switch; and
   the additional branch of the USB bus is isolated from USB bus portion connected to the at all times,
the KVM switch is adapted to detect external video and audio input to the computer via external video and audio input ports and generate a power down signal for the mother board to cause the CPU and the USB power supply to power down for economy whilst external video is detected.

### BRIEF DESCRIPTION OF THE DRAWINGS

To help understanding of the invention, two specific embodiments thereof will now be described by way of example and with reference to the accompanying drawings, in which:

FIG. 1 is a perspective view of an all-in-one computer equipped with a KVM switch in accordance with the invention;

FIG. 2 is a diagram of mechanical equivalent of the KVM switch;

FIG. 3 is a perspective view of the computer of FIG. 1 together with a keyboard and mouse, connected to a laptop computer for its control;

FIG. 4 a block diagram of the computer of FIG. 1, including the KVM switch, connected to the laptop computer;

FIG. 5 is a block diagram of a second computer equipped with a KVM switch in accordance with the invention.

### DETAILED DESCRIPTION OF THE PREFERRED EMBODIMENT

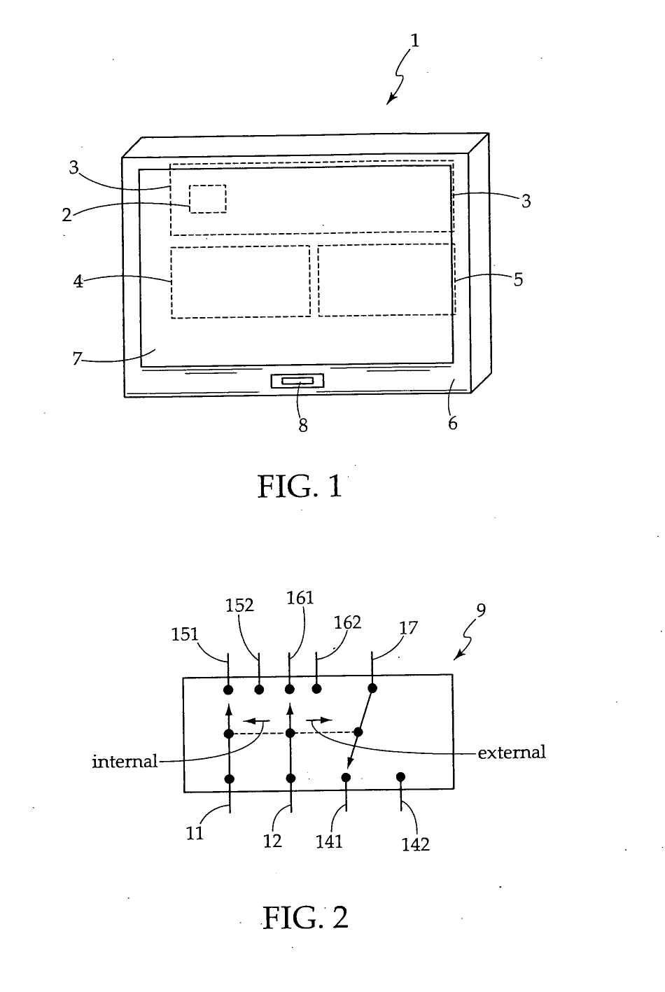

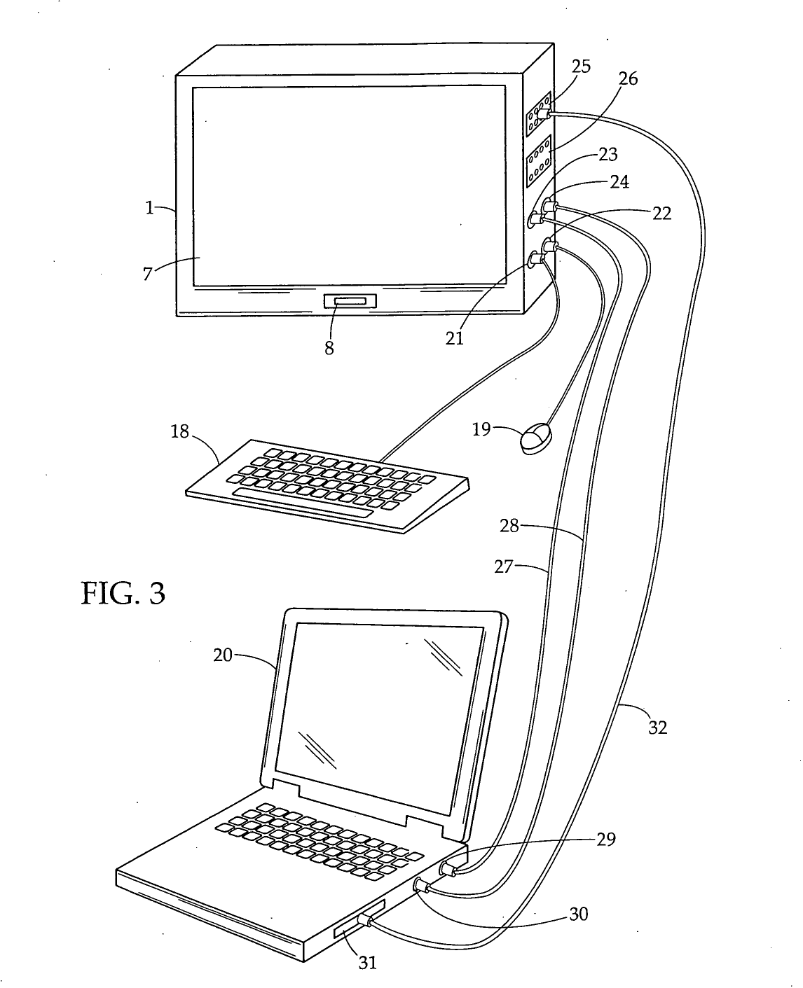

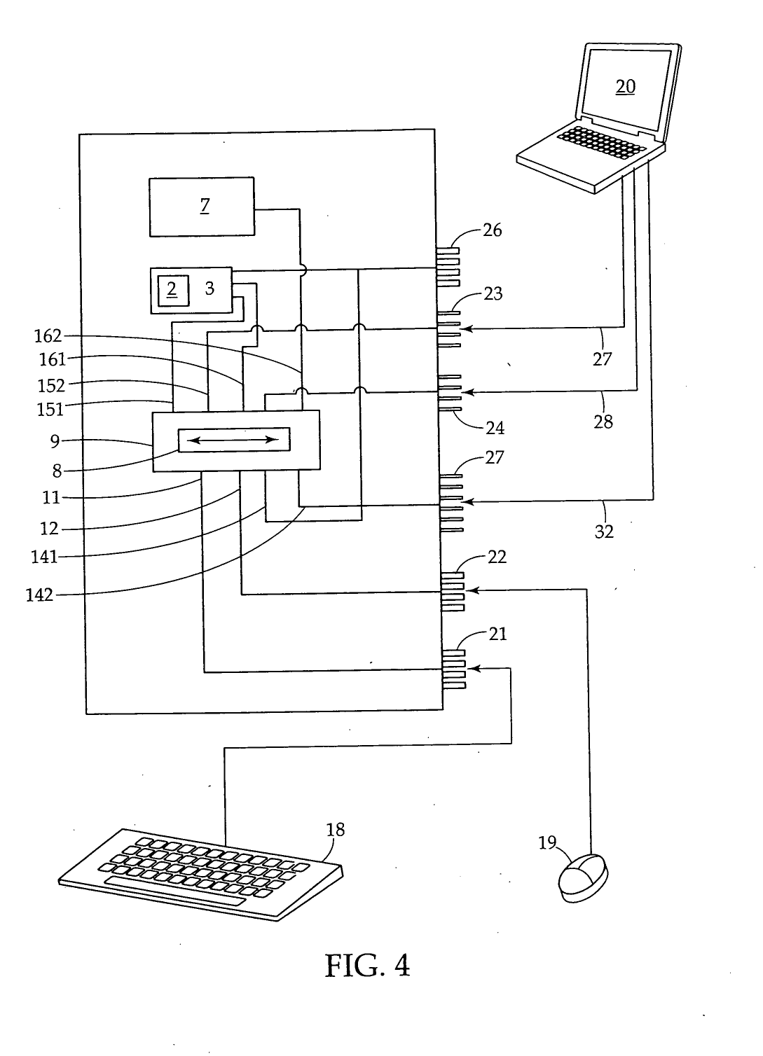

Referring first to FIGS. 1 to 4, the computer 1, which is typically of the type known as an all-in-one computer, i.e. having its central processor unit 2, mother board 3, memory 4 and hard disk drive 5 all mounted in a housing 6 with its VDU 7. A switch button 8 is exposed on the front of the housing.

The switch button is for a KVM switch 9, that is a switch for switching manual, that is keyboard and mouse input data and VDU data.

The KVM switch is configured conventionally as shown in FIG. 2. It has a keyboard data input connection 11, a mouse data input connection 12, and two VDU data input connections 141,142. It has two keyboard 151,152 and two mouse data output connections 161,162 and one VDU data output connection 17. It is an electronic device, however for simplicity FIG. 2 shows it diagrammatically as an electromechanical switch with connection being made from the connections 11,12,17 to either of connections 141,151,161 or 142,152,162, that is to say it connects a keyboard 18 and mouse 19 to either of the all-in-one computer 1 and an external, laptop computer 20 and either of their VDU data signals to the all-in-one's VDU 7.

Internally of the housing connections are made to the KVM switch from the keyboard and mouse output connections 151, 161 to the mother board 3 and for the VDU data from the mother board to the VDU input connection 141. Further VDU connection is made from the VDU output connection 17 to the VDU itself 7.

The all-in-one computer 1 is provided with conventional input connectors 21,22 for its keyboard and mouse. For illustrative purposes, these are shown as the conventional female pin type, although for practical purposes, they are more likely to be USB connectors as in the second embodiment below. To effect the connection to the laptop 20, the all-in-one is provided with a further pair male pin connectors 23,24. Of these, the input connectors 21,22 are wired to the KVM switch input connections 11,12 and the output connectors 23,24 are wired to the output connections 152,162. Further, the all-in-one is provided with a male pin, VDU input connector 25, which is wired to the KVM switch input connection 142. This connector is discrete from and unconnected to a conventional auxiliary VDU output connector 26, which is of the female pin type.

With the switch button slid to its Internal position, the KVM switch connects the keyboard and mouse to the all-in-one's mother board and the mother board to the VDU. The extra connectors 23,24,25 are isolated. Thus the computer can be operated normally.

With switch button slid to its External position, the KVM switch isolates the mother board as regards keyboard and mouse input and VDU output. The keyboard and mouse are connected, via the connectors 23,24, a pair of cables 27,28 and the laptop's auxiliary mouse and keyboard input connectors 29,30, as auxiliary controls for the laptop 20. Its auxiliary VDU output connector 31 is connected by a VDU cable 32 to the VDU input connector 25. This is connected by the KVM switch to the all-in-one's VDU 7. Thus the laptop can be controlled by the keyboard 18 and mouse 19 and its VDU output display on the VDU 7.

The user can switch between which computer and its software running at the time he chooses by simply actuating the switch mounted on the all-in-one computer.

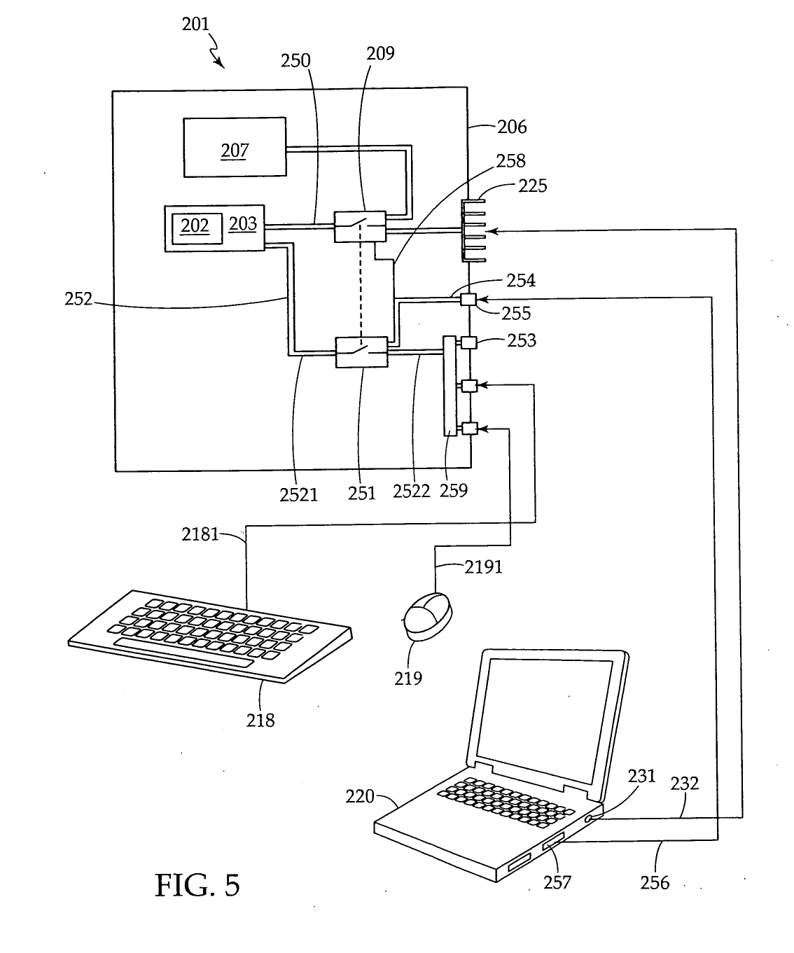

Turning now to FIG. 5, a second all-in-one computer 201 in accordance with the invention will now be described with reference to the block diagram of FIG. 5 only, constructional details being believed to be within the capabilities of the skilled reader in view of the description of the first embodiment. The computer 201 has amongst other components:
a central processor unit 202,
a mother board 203,
a housing 206,
a VDU 207.

Internally, the computer has a KVM switch 209, which does not have a manually operable control. It is positioned in the VDU bus 250 between the mother board 203 and the VDU 207 for interconnection of the two or their isolation. The switch is also connected to a VDU input connector 225 for connection of the VDU 207 to an external VDU source when the VDU 207 is not connected to the mother board 203 and vice versa.

A USB switch 251 is provided between in the computer's USB bus 252 between the mother board and the computer's Type A USB sockets 253. The USB switch is under the control of the KVM switch and interconnects the portions 2521,2522 of the USB bus on either side of it when the KVM switch interconnects these portions of the video bus. The USB switch also has an additional branch of USB bus 254 connected to it, which branch is isolated when the portions 2521, 2522 are interconnected. When these portions are isolated from each other by the USB switch, it connects the bus portion 2522, connected to the USB sockets 253, to the bus branch 254. The remote end of this terminates in a Type B USB socket 255. It should be noted that USB branch 254 is isolated from USB bus portion 2521 at all times.

A keyboard 218 and a mouse 219 are connected via USB cables 2181, 2191 to a pair of the Type A USB sockets 253, for control of the all-in-one when the KVM switch connects the two portions of the VDU bus and the USB switch connects the two portions of the USB bus.

A laptop 220 is connected to the all-in-one via a VDU cable 232 from the laptop's auxiliary VDU output connector 231 to the all-in-one's VDU input connector 225. Also a USB cable 256 connects the Type B USB socket 255 to one of the laptop's Type A USB sockets 257.

Connection of the cable 256 from the laptop to the Type B socket applies 5v across the cable's pair for powering peripherals to the corresponding pair of the USB bus branch 254 which is isolated by the USB switch on connection. The power pair are connected to the KVM switch via line 258. This on detecting the 5v applied to it changes state, causing the USB switch to change state. Whereupon, the all-in-one's mother board is no longer connected to the Type A USB sockets 253 nor to its VDU 207. The latter is connected to receive the laptop's VDU data. The sockets 253 become connected to the laptop's USB bus and the keyboard and mouse are now connected for control of the laptop.

It should be noted that the KVM switch is described as such although it switches only the VDU bus. However, this description is regarded as appropriate since it directly controls the USB switch and this in effect it switches the USB bus and with it the keyboard and mouse.

It will be understood that although a single USB cable is provided, USB protocol provides for multiplexing of data and keyboard and mouse data to be sent via the single USB cable by combining the separate USB device connections with a USB hub 259.

It will be appreciated that no manual intervention is necessary for KVM switching, beyond the plugging of the cable 256 from the laptop, or indeed any equivalent computer, into the Type B socket 255.

In a variant in which the keyboard and mouse are integrated with the all-in-one computer, they are nevertheless connected to its USB bus on the side of the USB switch remote from the mother board. KVM operation is exactly as if they were connected via the sockets 253.

In another variant, the KVM switch is further adapted to detect external video and audio input to the computer 1 via its external video and audio input ports. In this event, it generates a power down signal which is sent to the mother board to cause the central processing unit to power down for economy whilst external video is detected. Other devices such as the USB power supply are also powered down, whilst the VDU and audio circuit power supplies continue to supply their power.

In a further variant the USB switch is a USB hub.

The invention is not intended to be restricted to the details of the above described embodiment. For instance, where the computer has another device, such as a touch screen, to perform the function of the mouse that can be connected to the KVM switch in the same manner, to allow control via it of the other computer.

I claim:

1. A computer adapted to receive external keyboard, mouse and video data, the computer comprising:
a housing;
a visual display unit (VDU) mounted on the housing;
a central processor unit (CPU) contained in the housing and adapted to accept to keyboard and mouse input and to provide video data output;
keyboard and mouse data input means on mounted on the housing;
video data input means mounted on the housing;
keyboard and mouse data output means mounted on the housing;
keyboard, mouse and video (KVM) switch means mounted on or in the housing and connected to:
the keyboard and mouse data input means to receive external keyboard and mouse data and switch this data to the central processor unit in one state of the switch means or to the keyboard and mouse data output means in another state of the switch means and to
the CPU and the video data input means:
to receive video data from the CPU in one state of the switch means and switch this data to the VDU and
to receive external video data from the video data input means in another state of the switch means and switch this data to the VDU and
means for changing the state of the KVM switch means.

2. A computer according to claim 1, wherein the KVM switch means is an electromechanical switch.

3. A computer according to claim 1, wherein the KVM switch means is an electronic switch device.

4. A computer according to claim 2, wherein the KVM switch means embodies means for switching for all of the keyboard, mouse and VDU data in a single device.

5. A computer according to claim 3, wherein the KVM switch means comprises:
a first device for switching the video data and
a second device controlled by the first device for switching the keyboard and mouse data.

6. A computer according to claim 1, wherein the KVM switch means is a switch having two states only for switching between the KVM switch equipped computer and only one other computer.

7. A computer according to claim 1, wherein the KVM switch means is a switch having more than two states for switching keyboard and mouse data to a selected one of a plurality of other computers and switching video data from the selected other computer to the VDU of the KVM switch equipped computer.

8. A computer according to claim 1, wherein the KVM switch means is a manually operated switch.

9. A computer according to claim 1, wherein the KVM switch means is an electrically operated switch, adapted to be operated by detection of connection to another computer.

10. A computer according to claim 1, wherein the KVM switch means is a keyboard operated switch, adapted to be operated by detection of a unique keystroke sequence.

11. A computer according to claim 1, wherein the keyboard and mouse data output means is a Type B USB socket.

12. A computer according to claim 1, wherein the computer is a laptop computer.

13. A computer according to claim 1, wherein the computer is an all-in-one computer.

14. A computer according to claim 1, wherein the computer includes:
a mother board on which the CPU is carried and
a video bus from the mother board to the VDU and wherein:
the KVM switch means includes a video switch:
positioned in the video bus between the mother board and the VDU for interconnection of these two or their isolation; and
connected to the VDU data input means for connection thereof to the VDU when the VDU is not connected to the mother board and vice versa.

15. A computer according to claim 14, wherein the computer includes:
a USB bus connected to the mother board and wherein:
the keyboard and mouse data input means includes:
one or more Type A USB socket connected to the USB bus for connection of a keyboard and a mouse and wherein
the KVM switch means includes
a USB switch is provided between in the USB bus between the mother board and the Type A USB sockets;
wherein the USB switch interconnects portions of the USB bus on either side of it when the video switch interconnects the video bus between the mother board and the VDU.

16. A computer according to claim 15, wherein the keyboard and mouse data output means comprises:
a Type B USB socket and
the computer includes
an additional branch of the USB bus connected between the USB switch and the Type B USB socket and
wherein:
the USB switch is arranged to isolate the additional branch of the USB bus when the said portions of the USB bus are interconnected;
the USB switch connects the portion of the USB bus connected to the Type A USB sockets to the additional branch of the USB bus and the Type B USB socket, when the said portions are isolated from each other by the USB switch; and
the additional branch of the USB bus is isolated from USB bus portion connected to the mother board at all times.

17. A computer according to claim 14, wherein the computer includes:
a USB bus connected to the mother board and wherein:
the keyboard and mouse data input means includes:
one or more Type A USB socket connected to the USB bus for connection of a keyboard and a mouse and wherein
the keyboard and mouse data output means comprises:
a Type B USB socket and
an additional branch of the USB bus connected to the Type B USB socket and
the KVM switch means includes
a USB hub having two upstream port and one downstream port and means for selectively switching the one or the other of the two upstream ports to the downstream port and wherein
the downstream port is connected to the or each Type A USB socket for connection of keyboard and mouse data,
one upstream port is connected to the mother board via the USB bus for connection of the keyboard and mouse data thereto,
the other upstream port is connected to the Type B USB socket via the additional branch of the USB bus for connection to an external computer for connection of the keyboard and mouse data thereto.

18. A computer according to claim 16, wherein the KVM switch is connected to the Type B USB socket and is adapted to:
change state and isolate the said portions of the video bus on application of 5 volts from the Type B USB socket to the KVM switch and to
pass a signal to the USB switch whereby the USB switch disconnects the portions of the USB bus on either side of it when the video switch disconnects the video bus between the mother board and the VDU.

19. A computer according to claim 17, wherein the KVM switch is connected to the Type B USB socket and is adapted to:
change state and isolate the said portions of the video bus on application of 5 volts from the Type B USB socket to the KVM switch and to
pass a signal to the USB hub whereby the USB hub disconnects the one upstream port from the downstream port when the video switch disconnects the video bus between the mother board and the VDU.

20. A computer according to claim 14, including:
an integral keyboard,
an integral mouse,
a USB bus to which the keyboard and mouse are connected, and
a USB switch is provided between in the USB bus between the mother board and the keyboard and mouse; and
wherein the USB switch is under the control of the KVM switch and interconnects portions of the USB bus on either side of it when the KVM switch interconnects the said portions of the video bus.

21. A computer according to claim 20, including:
a Type B USB socket and
an additional branch of the USB bus connected between the USB switch and the Type B USB socket and
wherein:
the USB switch is arranged to isolate the additional branch of the USB bus when the said portions of the USB bus are interconnected;
the USB switch connects the portion of the USB bus connected to the Type A USB sockets to the additional branch of the USB bus and the Type B USB socket, when the said portions are isolated from each other by the USB switch; and
the additional branch of the USB bus is isolated from USB bus portion connected to the at all times.

22. A computer according to claim 15, wherein the KVM switch is adapted to detect external video and audio input to the computer via external video and audio input ports and generate a power down signal for the mother board to cause the CPU and the USB power supply to power down for economy whilst external video is detected.
